(19) United States
(12) Patent Application Publication
(10) Pub. No.: US 2002/0112751 A1
(43) Pub. Date: Aug. 22, 2002

(54) Snap bolt for adjustable crutch

(76) Inventor: Kyungil-Cho, Goyang City (KR)

Correspondence Address: Bradley M. Knepper, SHERIDAN ROSS P.C., Suite 1200, 1560 Broadway, Denver, CO, 80202-5141, US

(21) Appl. No.: 10/079,716

(22) Filed: Feb. 19, 2002

(30) Foreign Application Priority Data
Feb. 20, 2001 (KR) 01-008501

(51) Int. Cl. A61H 3/02

(52) U.S. Cl. 135/68

(57) ABSTRACT

A snap bolt for an adjustable crutch is provided. The snap bolt is adapted to be quickly and easily disengage from a crutch assembly to allow the height of the crutch and the height of a crutch handle to be adjusted. In particular, the present invention provides a snap slider at a first end of a shaft that can be positioned such that the end of the snap bolt can be inserted through holes provided in the crutch assembly. The snap slider may be moved to a second position in which the position of the snap slider is fixed with respect to the crutch assembly. A second end of the shaft is threaded such that the snap bolt assembly can be secured to the crutch assembly.

### CROSS-REFERENCE TO RELATED APPLICATIONS

This application claims the benefits under 35 U.S.C. §119 from Korean Patent Application Serial No. 01-008501 entitled “Snap Bolt of Adjustable Crutch,” filed on Feb. 20, 2001, which is incorporated herein by reference in its entirety.

### FIELD OF THE INVENTION

The present invention relates to a medical crutch. In particular, the present invention relates to a snap bolt for facilitating adjustments to height adjustable crutches.

### BACKGROUND OF THE INVENTION

Prior art adjustable crutches, such as the crutch illustrated in FIG. 4, typically include side bow tubes 102, a bottom middle tube 100 and a handle 18. Such crutches are adjusted using a common threaded nut 104 and bolt 108. In order to adjust the crutches, the nut 104 and bolt 108 must be unthreaded, the bolt withdrawn, the height of the bottom middle tube 100 or the handle 18 adjusted, and the nut 104 and bolt 108 reassembled. Therefore, conventional crutches are difficult and inconvenient for a patient to adjust.

### SUMMARY OF THE INVENTION

In accordance with the present invention, snap bolt assemblies are used to facilitate adjustment of height adjustable crutches. Each snap bolt assembly generally comprises a shaft that features a slot into which a snap slider is inserted. The second end of the snap bolt shaft is threaded on at least a first end for receiving a threaded nut. The snap slider is pinned within the slot of the bolt. A slot formed in the snap slider allows the snap slider to travel along the pin. When the snap slider is positioned such that the pin is at about a center of the snap slider, the major axis of the snap slider is perpendicular to the major axis of the bolt. In this first configuration, the snap slider is configured to secure the middle tube or handle relative to the other components of the crutch. In order to adjust the crutch, the threaded nut maybe loosened, and the snap slider repositioned such that the pin is located at an end of the slot, and such that the longitudinal axis of the snap slider is substantially parallel to the longitudinal axis of the bolt. In this second configuration, the snap bolt assembly may be easily withdrawn to allow adjustment of the crutch.

Additional advantages of the present invention will become readily apparent from the following discussion, particularly when taken together with the accompanying drawings.

### BRIEF DESCRIPTION OF THE DRAWINGS

FIG. 1 is a partial illustration of a crutch in accordance with the present invention;

FIG. 2A is a partial cross-section of a snap bolt assembly in accordance with an embodiment of the present invention;

FIG. 2B is a partial cross-section of a crutch bow tube in accordance with an embodiment of the present invention;

FIG. 2C is a partial cross-section of a crutch bow tube and a snap bolt assembly in a second position in accordance with an embodiment of the present invention;

FIG. 2D is a cross-section of a crutch bow tube and snap bolt assembly in a first position in accordance with an embodiment of the present invention;

FIG. 3 is a top perspective view of a snap bolt assembly in accordance with an embodiment of the present invention; and

FIG. 4 is a partial exploded perspective view of an adjustable crutch in accordance with the prior art.

### DETAILED DESCRIPTION OF THE INVENTION

In the following, an embodiment of the present invention will be described in detail in connection with the figures. The same reference numbers will be used throughout the various drawings to describe like components.

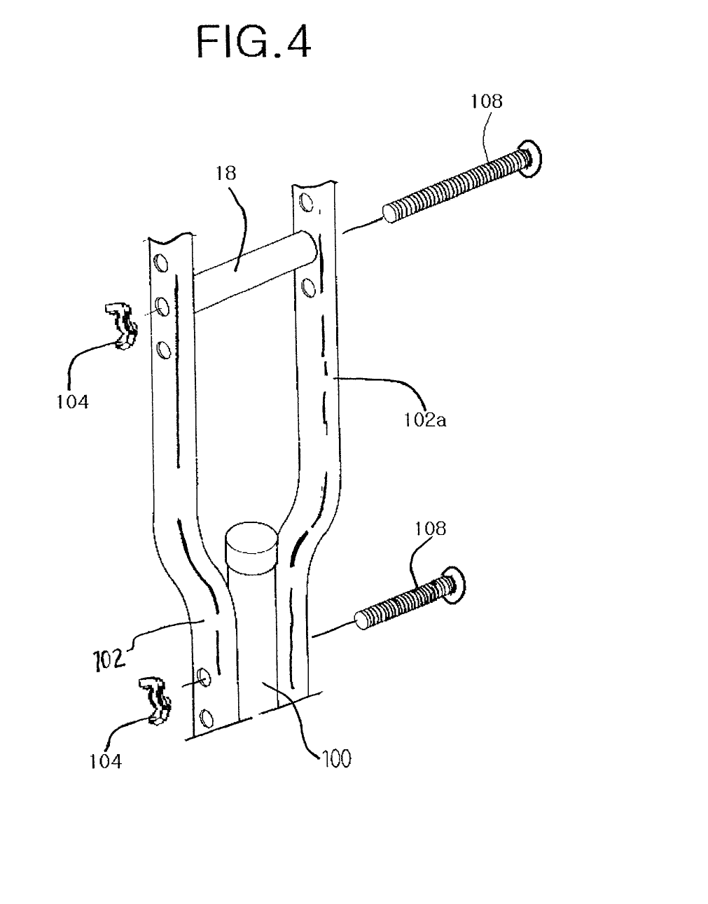

With reference now to FIG. 4, conventional height adjustable aluminum crutches including a middle bottom tube 100, side bow tubes 102, 102a, threaded nuts 104, and bolts 108 are illustrated. Adjusting the height of such crutches requires unthreading the nuts 104 from their mating bolts 108, withdrawing the bolts 108, making the desired adjustment, reinserting the bolts 108 and reattaching the nuts 104.

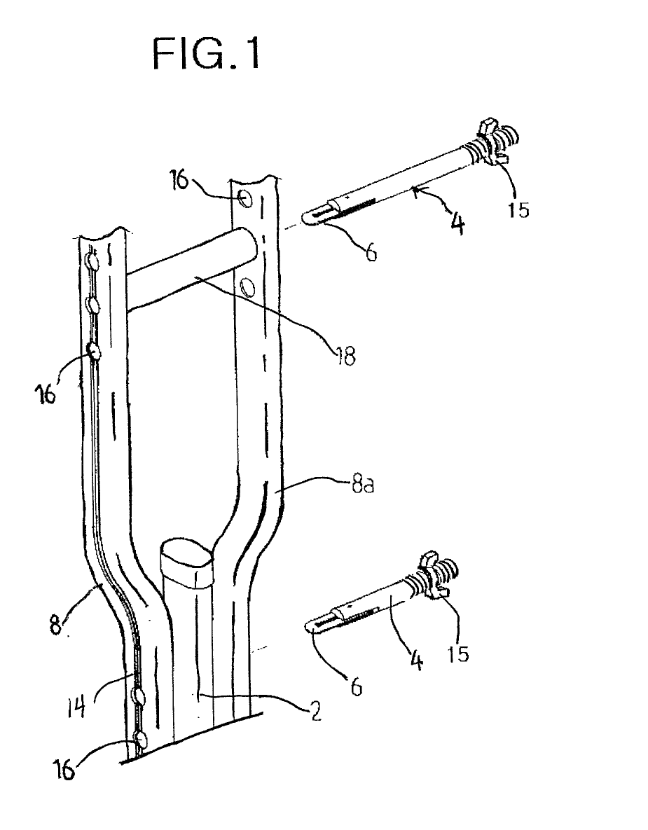

With reference now to FIG. 1, a crutch assembly 1 in accordance with an embodiment of the present invention is shown in a partial exploded perspective view. The adjustable crutches 1 generally comprise side bow tubes 8, 8a, with a narrow groove 14 formed in at least one side bow tube 8 or 8a in areas adjacent to holes 16. The holes 16 are arranged along the length of the side bow tubes 8, 8a to provide different adjustment positions for the middle bottom tube 2 and the handle 18. The middle bottom tube 2 and the side bow tubes 8, 8a are interconnected to one another by at least one snap bolt assembly 4, which is received by the holes 16. Similarly, the handle 18 is interconnected to the side bow tubes 8, 8a by one or more snap bolt assemblies 4 received by holes 16.

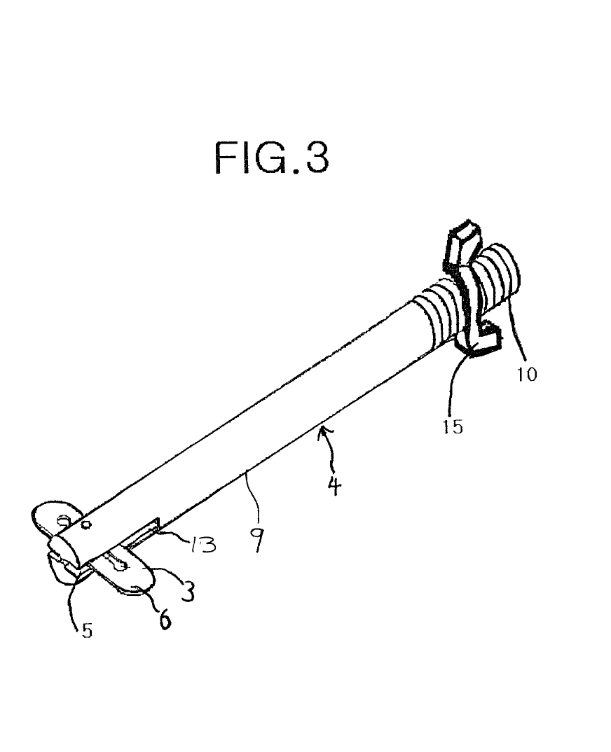

With reference now to FIG. 3, the snap bolt assembly 4 generally comprises a shaft 9, a snap slider 6 at a first end of the shaft 9, and a threaded portion 10 at a second end of the shaft 9 to which a threaded nut 15 may be interconnected. When fastening the middle bottom tube 2 or the handle 18 to the side bow tubes 8, 8a, a snap bolt assembly 4 is inserted through the appropriate hole 16 in the side bow tube 8, 8a and through the middle bottom tube 2 or handle 18, and through the opposite side bow tube hole 16. In order to insert a snap bolt assembly 4 through a hole 16, the snap slider 6 is turned such that its longitudinal axis is substantially parallel to the longitudinal axis of the shaft 9. After the snap bolt assembly is inserted through both side bow tubes 8, 8a and the middle bottom tube 2 or the handle 18, the snap slider 6 is turned such that its longitudinal axis is substantially perpendicular to the longitudinal axis of the shaft 9. The nut 15 is then tightened on the threaded portion 10 of the shaft 9 until the snap slider 6 is securely seated in the groove 14 of the side bow tube 8 or 8a.

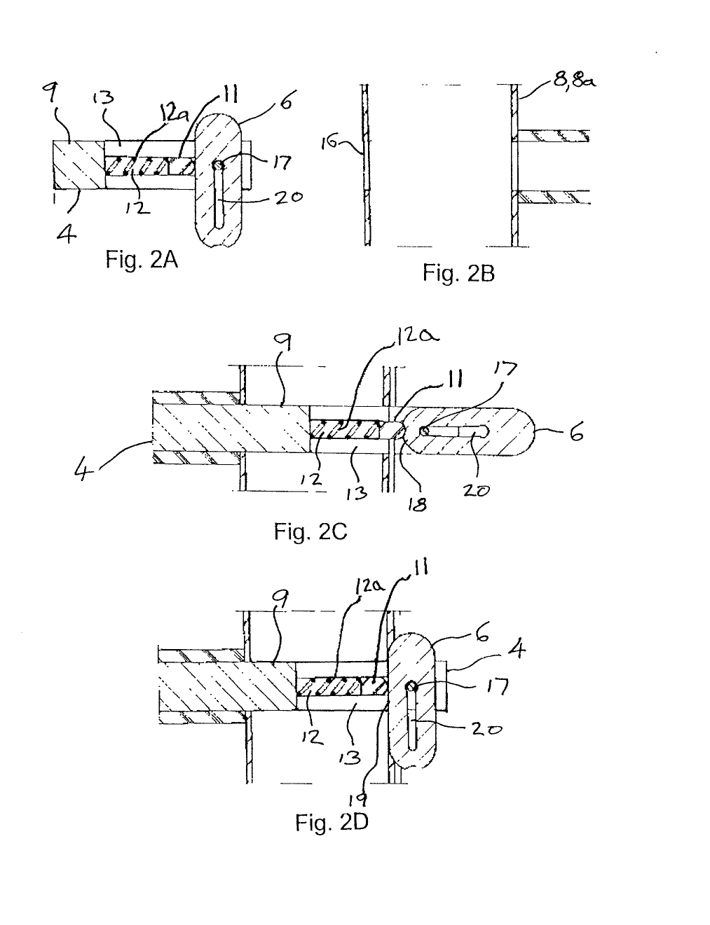

With reference now to FIGS. 2A, 2C and 2D, the first end of the snap bolt assembly 4 is shown in various cross-sectional views. The snap slider 6 is positioned at least partially within a shaft slot 13 formed in the end of the shaft 9. The shaft slot 13 may comprise a hole 12 that is substantially coaxial to the shaft 9 into which a spring 12a is inserted. The snap slider 6 is retained in the slot 13 by a pin 17 that is fixed to the shaft 9 and that passes through a longitudinal slot 20 formed in the snap slider 6. A metal projection stopper 11 may be inserted between the end of the spring 12a and the edge of the slider 6. The spring 12a and projection stopper 11 stabilize the position of the slider 6 with respect to the shaft 9. In particular, when the snap slider 6 is positioned such that its longitudinal axis is parallel to the longitudinal axis of the shaft 9 (see FIG. 2C), the end 18 of the snap slider 6 is held between the pin 17 and the projection stopper 11. When the snap slider 6 is positioned such that its longitudinal axis is perpendicular to the longitudinal axis of the shaft 9 (see FIG. 2D), the side 19 of the snap slider 6 is held between the pin 17 and the projection stopper 11.

As shown in the above description, the snap bolt assembly 4 of the present invention provides for the convenient adjustment of the crutch's height (i.e. the position of the middle bottom tube 2 relative to the side bow tubes 102, 102a) and/or the height of the handle 18. Furthermore, the snap bolt assembly 4 of the present invention allows adjustments to be made to a crutch assembly 1 without separating the threaded nut 15 from the shaft.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. An adjustable crutch assembly, comprising:
a side bow tube, wherein said side bow tube comprises holes and a small groove formed along a length of said bow tube in order to receive a snap slider of a snap bolt assembly;
at least one of a middle bottom tube and a handle interconnected to said side bow tube by said snap bolt assembly.

2. An adjustable crutch assembly as set forth in claim 1, comprising:
a longitudinal slot formed in said snap slider, wherein said snap slider may move around a center pin at a first end of said snap bolt assembly; and wherein a second end of said snap bolt assembly comprises a threaded portion and a nut.

3. An adjustable crutch snap bolt assembly as set forth in claim 2, wherein said first end of said snap bolt assembly has a hole drilled into it, said snap bolt assembly further comprising a spring and a projection stopper positioned inside said bolt of said first end of said snap bolt assembly to ensure stability of the snap slider.

4. A bolt for an adjustable crutch comprising:
a shaft, comprising:
a slotted first end;
a threaded second end;
a snap slider, wherein said snap slider is positioned at least partially within said slot of said shaft, wherein said snap slider map occupy a first position in which a longitudinal axis of said snap slider is perpendicular to a longitudinal axis of said shaft and a second position in which a longitudinal axis of said snap slider is parallel to a longitudinal axis of said shaft; and
a nut for engagement with said threaded second end of said shaft.

5. The snap bolt assembly of claim 4, further comprising a spring positioned within said slot of said shaft, wherein a position of said snap slider is stabilized.

6. The snap bolt assembly of claim 5, wherein a projection stopper is biased against said snap slider by said spring.
